(19) United States
(12) Patent Application Publication
(10) Pub. No.: US 2014/0287306 A1
(43) Pub. Date: Sep. 25, 2014

(54) ELECTRODE MATERIAL, METHOD FOR MANUFACTURING ELECTRODE MATERIAL, AND SECONDARY BATTERY

(71) Applicant: Sony Corporation, Tokyo (JP)

(72) Inventors: Kazumasa Takeshi, Kanagawa (JP); Seiichiro Tabata, Kanagawa (JP); Hironori Iida, Kanagawa (JP); Shun Yamanoi, Kanagawa (JP); Yosuke Saito, Kanagawa (JP); Koichiro Hinokuma, Kanagawa (JP); Shinichiro Yamada, Kanagawa (JP)

(73) Assignee: Sony Corporation, Tokyo (JP)

(21) Appl. No.: 14/356,356

(22) PCT Filed: Jul. 19, 2013
(86) PCT No.: PCT/JP2013/004415

§ 371 Date: May 5, 2014

(30) Foreign Application Priority Data
Aug. 9, 2012 (JP) 2012-177114

(51) Int. Cl. H01M 4/66; C01B 31/12; H01M 10/052; H01M 4/136; H01M 4/80

(52) U.S. Cl. CPC H01M 4/663; H01M 4/136; H01M 4/803; H01M 10/052; C01B 31/12; H01M 2004/021
USPC 429/213; 429/218.1; 428/402; 429/235; 423/445 R; 423/460

(57) ABSTRACT

An electrode material is provided. The electrode material includes a porous carbon material, wherein the porous carbon material has a half-width of diffraction intensity peak of a (100) face or a (101) face of 4 degrees or less with reference to a diffraction angle 2 theta on a basis of an X-ray diffraction method. An absolute value of a differential value of mass can be obtained when a mixture of the porous carbon material and S₈ sulfur mixed at a mass ratio of 1:2 is subjected to thermal analysis, where temperature is employed as a parameter, has a value of more than 0 at 450° C. and a value of 1.9 or more at 400° C. A battery and method of manufacture are also provided.

### TECHNICAL FIELD

The present disclosure relates to an electrode material, a method for manufacturing the electrode material, and a secondary battery.

### BACKGROUND ART

A lithium-sulfur secondary battery has been developed, where a sulfur simple substance is used as a positive electrode active material and lithium (Li) is used as a negative electrode active material. The theoretical capacity densities of lithium and sulfur are about 3,862 mAh/g and about 1,672 mAh/g, respectively, and it is believed that a secondary battery having a very high energy density can be obtained. However, the facts that

(1) the utilization factor of sulfur as a positive electrode active material is low and
(2) the charge-discharge cycle characteristics are poor can be mentioned as the reasons for which the lithium-sulfur secondary battery has not been commercialized at the present stage. A very large theoretical capacity density, which is a characteristic of the lithium-sulfur secondary battery, has not been utilized to the full.

As for the causes of the above-described item (1), the following reasons are considered. That is, in discharge, a lithium ion reacts with S₈ sulfur in a positive electrode, so as to generate sulfide Li₂Sₓ. As this reaction proceeds, the value of x changes from 8 to 4, 2, and 1. When the value of x is 8, 4, and 2, a portion which dissolves into an electrolytic solution is generated in Li₂Sₓ. Then, the reaction proceeds and when the dissolved sulfide becomes Li₂S (that is, x=1), this sulfide is insoluble into the electrolytic solution and is precipitated, so as to damage an electrode. Therefore, at the present, the sulfide can be subjected to discharge until x=2 (theoretical capacity density: 836 mAh/g) is approached.

As for the above-described item (2), causes are believed to be that sulfur (for example, S₈ sulfur) is an insulating material having an electric resistance value of 10⁻³⁰ ohm/cm and polysulfide is eluted into an electrolytic solution. In addition, there is also a problem in that, in charge, a cut-off voltage is not reached and a state of overcharge is induced because of a redox shuttle reaction in which polysulfide eluted into the electrolytic solution is reduced on the negative electrode to generate polysulfide having a shorter sulfur chain and the resulting polysulfide is moved to the positive electrode so as to be oxidized again.

### CITATION LIST

### Patent Literature

### [PTL 1]

Japanese Unexamined Patent Application Publication No. 2010-257689

### Non Patent Literature

### [NPL 1]

L. Nazar et al., Nature Materials, 8, 500, 2009

### [NPL 2]

M. Watanabe et al., Chem. Commun., 47, 8157-8159 (2011)

### SUMMARY

### Technical Problem

As for a method to solve the above-described problems, a method can be mentioned, in which sulfur is inserted into a porous carbon material. Consequently, an electrically conductive substance is allowed to present in the vicinity of a sulfur component, and electrons can move easily. Meanwhile, sulfur can be held in gaps of the porous carbon material and, in addition, sulfur and lithium ions react in the gaps, so that outflow of the generated sulfide from the gaps to the outside can be prevented. In general, Ketjenblack which is a nano-carbon material having a hollow structure including a graphene layer, carbon black, and acetylene black are used as the porous carbon material (refer to PTL 1, for example). As for other porous materials, a system in which sulfur is held in gaps of rod-shaped nano-carbons (refer to NPL 1) and a system in which sulfur is held in inverse opal carbon (refer to NPL 2) are mentioned in the related art. However, proposals of porous carbon materials having electrical conductivity and optimum gaps (size and volume) in combination are few in number, and only a little discussion has been made on an optimum gap.

It is desirable to provide an electrode material which can improve a utilization factor of active material and which is for obtaining a secondary battery having excellent characteristics, a method for manufacturing the electrode material, and a secondary battery by using such an electrode material.

### Solution to Problem

An electrode material for a secondary battery according to a first embodiment of the present disclosure is made from a porous carbon material exhibiting a half-width of diffraction intensity peak of the (100) face or (101) face of 4 degrees or less with reference to a diffraction angle 2 theta on the basis of an X-ray diffraction method. In an embodiment, the diffraction intensity peaks of the (100) face and the (101) face are overlapped and it is different to separate. Therefore, the diffraction intensity peak of the (100) face and the diffraction intensity peak of the (101) face are collectively expressed as described above. The same goes for the following explanations.

An electrode material for a secondary battery according to a second embodiment of the present disclosure is made from a porous carbon material, wherein an absolute value of a differential value of mass, that is obtained when a mixture of the porous carbon material and S₈ sulfur mixed at a mass ratio of 1:2 is subjected to thermal analysis, where temperature is employed as a parameter, (absolute value of −dW/dt) takes on a value of more than 0 at 450 degrees centigrade and a value of 1.9 or more at 400 degrees centigrade.

A secondary battery according to the first embodiment of the present disclosure includes an electrode made from a porous carbon material exhibiting a half-width of diffraction intensity peak of the (100) face or (101) face of 4 degrees or less with reference to a diffraction angle 2 theta on the basis of an X-ray diffraction method.

A secondary battery according to the second embodiment of the present disclosure includes an electrode made from a porous carbon material, wherein an absolute value of a differential value of mass, that is obtained when a mixture of the porous carbon material and S₈ sulfur mixed at a mass ratio of 1:2 is subjected to thermal analysis, where temperature is employed as a parameter, (absolute value of −dW/dt) takes on a value of more than 0 at 450 degrees centigrade and a value of 1.9 or more at 400 degrees centigrade.

A method for manufacturing an electrode material for a secondary battery according to the first embodiment of the present disclosure is a method for manufacturing an electrode material for a secondary battery made from a porous carbon material exhibiting a half-width of diffraction intensity peak of the (100) face or (101) face of 4 degrees or less with reference to a diffraction angle 2 theta on the basis of an X-ray diffraction method and includes carbonizing a plant-derived material at 400 degrees centigrade to 1,400 degrees centigrade, performing an acid or alkali treatment, and performing a heat treatment at a temperature higher than the carbonization temperature. In addition, a method for manufacturing an electrode material for a secondary battery according to the second embodiment of the present disclosure is a method for manufacturing an electrode material for a secondary battery which is made from a porous carbon material and which exhibits an absolute value of a differential value of mass, that is obtained when a mixture of the porous carbon material and S₈ sulfur mixed at a mass ratio of 1:2 is subjected to thermal analysis, where temperature is employed as a parameter, taking on a value of more than 0 at 450 degrees centigrade and a value of 1.9 or more at 400 degrees centigrade, and includes carbonizing a plant-derived material at 400 degrees centigrade to 1,400 degrees centigrade, performing an acid or alkali treatment, and performing a heat treatment at a temperature higher than the carbonization temperature. In another embodiment, a method of manufacturing an electrode material includes carbonizing a plant-derived material at a first temperature; performing an acid treatment or an alkali treatment on the carbonized plant-derived material to form a porous carbon material; and subjecting the porous carbon material to a heat treatment at a second temperature, wherein the second temperature is higher than the first temperature.

### Advantageous Effects of Invention

In the electrode material for a secondary battery and the method for manufacturing the electrode material according to the first embodiment of the present disclosure and the secondary battery according to the first embodiment of the present disclosure, the value of half-width of diffraction intensity peak of the (100) face or (101) face of the porous carbon material on the basis of an X-ray diffraction method is specified. That is, the porous carbon material has high crystallinity. Therefore, this porous carbon material has excellent electrical conductivity. The secondary battery in which this porous carbon material is used as an electrode can improve the utilization factor of an active material and, in addition, has excellent charge-discharge cycle characteristics.

In the electrode material for a secondary battery and the method for manufacturing the electrode material according to the second embodiment of the present disclosure and the secondary battery according to the second embodiment of the present disclosure, thermal behavior of a mixture of the porous carbon material and S₈ sulfur is specified. That is, even when heat is applied, sulfur does not leave the mixed system of the porous carbon material and S₈ sulfur easily. As a result, this porous carbon material is allowed to hold an active material in the pores thereof reliably and outflow of reaction products, which have been generated in gaps, of the active material from the pores to the outside can be prevented. Consequently, the utilization factor of the active material can be improved and, in addition, excellent charge-discharge cycle characteristics are exhibited.

In the method for manufacturing an electrode material according to the first embodiment or the second embodiment of the present disclosure, the heat treatment is performed at a temperature higher than the carbonization temperature, and a kind of densification of the porous carbon material occurs. As a result, a porous carbon material having gaps (size and volume) more suitable for the electrode material can be provided.

### BRIEF DESCRIPTION OF DRAWINGS

FIG. 1 is a graph showing measurement results of the X-ray diffraction intensity of porous carbon material in Example 1.

FIG. 2 is a graph illustrating a method for determining the half-width of diffraction intensity peak of the (100) face or (101) face on the basis of the measurement result of the X-ray diffraction intensity of porous carbon material.

FIG. 3 is a graph showing the TG measurement results of a mixture of a porous carbon material and S₈ sulfur and the like.

FIG. 4 is a graph showing absolute values of a differential value of mass, where temperature is employed as a parameter, (absolute value of −dW/dt) determined on the basis of the TG measurement results of a mixture of a porous carbon material and S₈ sulfur and the like.

FIG. 5A is a graph showing the result of determination of the charge-discharge capacity densities in discharge after production of a lithium-sulfur secondary battery, in which a porous carbon material in Example 1B was used as an electrode material, and the following charge.

FIG. 5B is a graph showing the result of determination of the charge-discharge capacity densities in discharge after production of a lithium-sulfur secondary battery, in which a porous carbon material intermediate was used as an electrode material, and the following charge.

FIG. 6A is a graph showing the result of impedance measurement after production of a lithium-sulfur secondary battery, in which a porous carbon material in Example 1B was used as an electrode material, the result of impedance measurement after discharge, and the result of impedance measurement after the following charge.

FIG. 6B is a graph showing the result of impedance measurement after production of a lithium-sulfur secondary battery, in which a porous carbon material intermediate was used as an electrode material, the result of impedance measurement after discharge, and the result of impedance measurement after the following charge.

### DESCRIPTION OF EMBODIMENTS

The present disclosure will be described below on the basis of the example with reference to the drawings. However, the present disclosure is not limited to the example, and various numerical values and materials in the example are exemplifications. The explanations will be made in the following order.

1. Explanations of the electrode materials, the methods for manufacturing the electrode materials, and the secondary batteries according to the first embodiment and the second embodiment of the present disclosure on the whole
2. Example 1 (the electrode materials, the methods for manufacturing the electrode materials, and the secondary batteries according to the first embodiment and the second embodiment of the present disclosure) and others (Explanations of the electrode materials, the methods for manufacturing the electrode materials, and the secondary batteries according to the first embodiment and the second embodiment of the present disclosure on the whole)

The electrode material according to the first embodiment of the present disclosure, the secondary battery according to the first embodiment of the present disclosure, and the method for manufacturing an electrode material for a secondary battery according to the first embodiment of the present disclosure may be collectively referred to as “the first embodiment according to the present disclosure” simply. The electrode material according to the second embodiment of the present disclosure, the secondary battery according to the second embodiment of the present disclosure, and the method for manufacturing an electrode material for a secondary battery according to the second embodiment of the present disclosure may be collectively referred to as “the second embodiment according to the present disclosure” simply. The first embodiment according to the present disclosure and the second embodiment according to the present disclosure may be collectively referred to as “the present disclosure” simply.

In the second embodiment according to the present disclosure, it is preferable that the half-width of diffraction intensity peak of the (100) face or (101) face of the porous carbon material be 4 degrees or less with reference to a diffraction angle 2 theta on the basis of an X-ray diffraction method.

In the present disclosure including the above-described preferred configurations, it is preferable that the porous carbon material have a value of specific surface area of 10 m²/g or more on the basis of a nitrogen BET method and a pore volume of 0.1 cm³/g or more on the basis of a BJH method and a MP method. In this case, it is preferable that the raw material for the porous carbon material be a plant-derived material having a silicon (Si) content of 5 percent by mass or more, although not limited thereto. It is desirable that the silicon (Si) content of the porous carbon material be less than 5 percent by mass, preferably 3 percent by mass or less, and more preferably 1 percent by mass or less.

In the method for manufacturing an electrode material for a secondary battery according to the first embodiment or the second embodiment of the present disclosure including the above-described preferred configurations, it is preferable that a silicon component in the plant-derived material after carbonization be removed by an acid or alkali treatment. Meanwhile, an activation treatment may be performed after the acid or alkali treatment, or the activation treatment may be performed before the acid or alkali treatment.

In the secondary battery according to the first embodiment or the second embodiment of the present disclosure including the above-described preferred configurations, a positive electrode may be formed from an electrode. Furthermore, the secondary battery may be made from a lithium-sulfur secondary battery, and the electrode may carry sulfur or a sulfur compound. The configuration and the structure of the secondary battery in itself may be the configuration and the structure in the related art. Sulfur may be S₈ sulfur and the sulfur compound may be insoluble sulfur, colloidal sulfur, and organic sulfur compounds (disulfide compounds, trisulfide compounds, and the like). Examples of methods for producing a positive electrode may include a method in which sulfur or a sulfur compound, a porous carbon material, and other materials are made into a slurry and the resulting slurry is applied to a base member constituting the positive electrode, a liquid infiltration method, a solution infiltration method, a PVD method, and a CVD method.

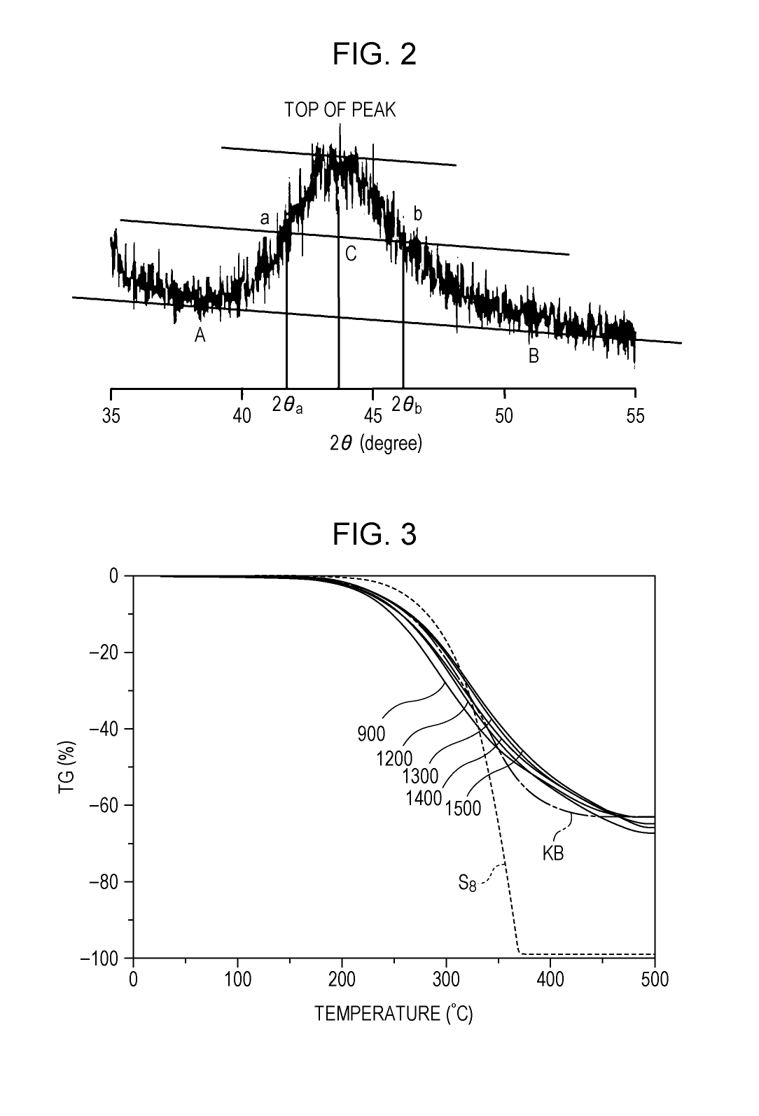

In the X-ray diffraction method, the Cu-K alpha line (wavelength: 0.15045 nm) is used as an X-ray source, the applied voltage is specified to be 50 kV, the scanning rate is specified to be 5 degrees/min, and the measurement is performed at the diffraction angle 2 theta of 10 degrees to 60 degrees. FIG. 2 shows an example of the measurement result of diffraction intensity. The point “A” at which the diffraction intensity exhibits a local minimum value between the diffraction angle 2 theta of 35 degrees centigrade and 40 degrees centigrade is determined. A straight line which is started from A and which is tangent to the diffraction intensity between the diffraction angle 2 theta of 50 degrees centigrade and 55 degrees centigrade is determined as a base line AB. The diffraction intensity (peak height) from the base line AB to the top of the diffraction intensity peak of the (100) face or (101) face is specified to be “100”. Points “a” and “b”, at which a straight line passing through a point C corresponding to the diffraction intensity of “50” and being parallel to the base line intersects with the diffraction intensity peak of the (100) face or (101) face, are determined. The diffraction angles 2 thetaₐ and 2 theta_{b} corresponding to the points “a” and “b”, respectively, are determined and, in addition, (2 thetaₐ−2 theta_{b}) is determined. The value of this (2 thetaₐ−2 theta_{b}) is the half-width of the diffraction intensity peak of the (100) face or (101) face.

In the second embodiment according to the present disclosure, the mixture of the porous carbon material and S₈ sulfur mixed at amass ratio of 1:2 is subjected to thermal analysis. Here, S₈ sulfur (manufacture's code 194-05712) produced by Wako Pure Chemical Industries, Ltd., is used. Then, 0.3000 g of porous carbon material and 0.6000 g of S₈ sulfur are pulverized and mixed in an agate mortar for 30 minutes and, thereafter, heating is performed at 155 degrees centigrade for 3 hours. Cooling to room temperature is performed, and a thermogravimetric analysis measurement (TG measurement) is performed by using, for example, “Thermo Plus” produced by Rigaku Corporation. Specifically, the TG measurement is performed from room temperature to 550 degrees centigrade at a temperature raising rate of 5 degrees centigrade/min in a nitrogen atmosphere.

Various elements can be analyzed by using, for example, an energy dispersive X-ray analyzer (for example, JED-2200F produced by JEOL LTD.) on the basis of an energy dispersive spectroscopy (EDS). As for the measurement condition, for example, the scanning voltage may be specified to be 15 kV, and the illumination current may be specified to be 10 microampares.

In the present disclosure, as described above, a material obtained by carbonizing a plant-derived material at 400 degrees centigrade to 1,400 degrees centigrade and, thereafter, performing an acid or alkali treatment may be referred to as a “porous carbon material intermediate” for the sake of convenience. Hereafter a method for manufacturing such a porous carbon material intermediate may be referred to as a “method for manufacturing a porous carbon material intermediate”. An electrode material for a secondary battery or a porous carbon material can be obtained by subjecting the porous carbon material intermediate to a heat treatment at a temperature higher than the carbonization temperature. A material which has been obtained by carbonizing a plant-derived material at 400 degrees centigrade to 1,400 degrees centigrade and which is before subjected to the acid or alkali treatment is referred to as a “porous carbon material precursor” or “carbonaceous substance”.

In the method for manufacturing the electrode material according to the first embodiment or the second embodiment of the present disclosure (hereafter these methods may be generically simply called “method for manufacturing the electrode material according to the embodiments of the present disclosure”), as described above, the activation treatment may be performed after the acid or alkali treatment or the acid or alkali treatment may be performed after the activation treatment is performed. In the method for manufacturing the electrode material according to the embodiments of the present disclosure including the above-described preferred configuration, before the plant-derived material is carbonized, the plant-derived material may be subjected to a heat treatment (pre-carbonization treatment) at a temperature (for example, 400 degrees centigrade to 700 degrees centigrade) lower than the carbonization temperature under the state in which oxygen is cut off, although depending on the plant-derived material employed. According to this, a tar component which may be generated during carbonization can be extracted and, as a result, the tar component which may be generated during carbonization can be reduced or removed during carbonization. In this regard, the state in which oxygen is cut off can be achieved by, for example, establishing an atmosphere of inert gas, e.g., a nitrogen gas or an argon gas, establishing a vacuum atmosphere, or bringing the plant-derived material into a kind of state of being baked in a casserole. In the method for manufacturing the electrode material according to the embodiments of the present disclosure, in order to reduce a mineral component and water contained in the plant-derived material or prevent an occurrence of off-flavor during carbonization, the plant-derived material may be immersed in alcohol (for example, methyl alcohol, ethyl alcohol, or isopropyl alcohol), although depending on the plant-derived material employed. In the method for manufacturing the electrode material according to the embodiments of the present disclosure, a pre-carbonization treatment may be performed thereafter. Preferable examples of materials to be subjected to a heat treatment in an inert gas atmosphere may include plants which generate large amounts of pyroligneous acid (tar and light oil). Preferable examples of materials to be subjected to a pretreatment with alcohol may include seaweed containing iodine and various minerals to a great extent.

In the method for manufacturing the porous carbon material intermediate, the plant-derived material is carbonized at 400 degrees centigrade to 1,400 degrees centigrade. The carbonization refers to conversion of an organic substance (in the present disclosure, plant-derived material) to a carbonaceous substance by a heat treatment (refer to, for example, JIS M0104-1984). As for the atmosphere for the carbonization, an atmosphere in which oxygen is cut off can be mentioned. Specifically, a vacuum atmosphere, an atmosphere of inert gas, e.g., a nitrogen gas or an argon gas, and an atmosphere in which the plant-derived material is brought into a kind of state of being baked in a casserole can be mentioned. The temperature raising rate to reach the carbonization temperature is not specifically limited, but 1 degree centigrade/min or more, preferably 3 degrees centigrade/min or more, and more preferably 5 degrees centigrade/min or more in the above-described atmosphere can be mentioned. The upper limit of the carbonization time may be 10 hours, preferably 7 hours, and more preferably 5 hours, although not limited to them. The lower limit of the carbonization time may be the duration in which the plant-derived material is carbonized reliably. The plant-derived material may be pulverized, as necessary, to have a predetermined particle size, or be classified. The plant-derived material may be washed in advance. Alternatively, the resulting porous carbon material precursor, porous carbon material intermediate, or porous carbon material may be pulverized, as necessary, to have a predetermined particle size, or be classified. Alternatively, the porous carbon material intermediate or porous carbon material after being subjected to the activation treatment may be pulverized, as necessary, to have a predetermined particle size, or be classified. The form, the configuration, and the structure of a furnace used for carbonization are not specifically limited, a continuous furnace may be employed, or a batch furnace may be employed.

As for the atmosphere for the heat treatment, an atmosphere in which oxygen is cut off can be mentioned. Specifically, a vacuum atmosphere, an atmosphere of inert gas, e.g., a nitrogen gas or an argon gas, and an atmosphere in which the plant-derived material is brought into a kind of state of being baked in a casserole can be mentioned. The temperature raising rate to reach the heat treatment temperature is not specifically limited, but 1 degree centigrade/min or more, preferably 3 degrees centigrade/min or more, and more preferably 5 degrees centigrade/minor more in the above-described atmosphere can be mentioned. The difference between the carbonization temperature and the heat treatment temperature may be determined appropriately by performing various tests. The upper limit of the heat treatment time may be 10 hours, preferably 7 hours, and more preferably 5 hours, although not limited to them. The lower limit of the heat treatment time may be the duration in which predetermined characteristics can be given to the porous carbon material. The form, the configuration, and the structure of a furnace used for heat treatment are not specifically limited, a continuous furnace may be employed, or a batch furnace may be employed.

In the method for manufacturing the electrode material according to the embodiments of the present disclosure, as described above, micropores (described later) having a pore diameter of smaller than 2 nm can be increased by performing the activation treatment. As for the activation treatment method, a gas activation method and a chemical activation method may be mentioned. The gas activation method refers to a method in which oxygen, steam, carbon dioxide, air, or the like is used as an activator, and the porous carbon material intermediate is heated in this gas atmosphere at 700 degrees centigrade to 1,400 degrees centigrade, preferably, 700 degrees centigrade to 1,000 degrees centigrade, and more preferably 800 degrees centigrade to 1,000 degrees centigrade for several ten minutes to several hours, so as to develop a fine structure by volatile components and carbon molecules in the porous carbon material intermediate. More specifically, the heating temperature in the activation treatment may be selected appropriately on the basis of the type of the plant-derived material, and the type, the concentration, and the like of the gas. The chemical activation method refers to a method in which activation is performed by using zinc chloride, iron chloride, calcium phosphate, calcium hydroxide, magnesium carbonate, potassium carbonate, sulfuric acid, or the like in place of oxygen or steam used in the chemical activation method, washing is performed with hydrochloric acid, the pH is adjusted with an alkaline solution, and drying is performed.

In the method for manufacturing the electrode material according to the embodiments of the present disclosure, a silicon component in the plant-derived material after carbonization is removed by the acid or alkali treatment. As for the silicon component, silicon oxides, e.g., silicon dioxide, silicon monoxide, and silicon oxide salts, may be mentioned. A porous carbon material having a high specific surface area can be obtained by removing a silicon component in the plant-derived material after carbonization, as described above. In some cases, a silicon component in the plant-derived material after carbonization may be removed on the basis of a dry etching method. That is, in a preferred configuration of the porous carbon material, plant-derived material containing silicon (Si) is used as a raw material. In the conversion to the porous carbon material precursor or the carbonaceous substance, the plant-derived material is carbonized at a high temperature (for example, 400 degrees centigrade to 1,400 degrees centigrade), so that silicon contained in the plant-derived material is not converted to silicon carbide (SiC), but is converted to silicon components (silicon oxides), e.g., silicon dioxide (SiO₂), silicon monoxide, and silicon oxide salts. In this regard, silicon components (silicon oxides) contained in the plant-derived material before carbonization are not substantially changed even when carbonization is performed at a high temperature (for example, 400 degrees centigrade to 1,400 degrees centigrade). Therefore, the silicon components (silicon oxides), e.g., silicon dioxide, silicon monoxide, and silicon oxide salts, are removed in the following step by the acid or alkali (base) treatment and as a result, a large specific surface area value on the basis of the nitrogen BET method can be obtained. In addition, the preferred configuration of the porous carbon material is a natural product-derived environment-compatible material, and the fine structure thereof is obtained by removing silicon components (silicon oxides) contained in advance in the raw material, which is a plant-derived material, through the acid or alkali treatment. Consequently, the arrangement of pores maintains the biological regularity in the plant.

As described above, the raw material of the porous carbon material can be a plant-derived material. As for the plant-derived material, hulls and straws of rice (paddy), barley, wheat, rye, barnyard grass, and millet, coffee beans, tea-leaves (for example, leaves of green tea, black tea, and the like), sugar canes (more specifically, bagasses of sugar canes), corn (more specifically, cobs of corn), fruit peels (for example, citrus peels, such as, orange peel, grapefruit peel, and mandarin orange peel, banana peel, and the like), reed, and wakame stem can be mentioned, although not limited to them. In addition, for example, terrestrial vascular plants, pteridophyte, bryophyte, algae, and sea grass can be mentioned. Further, the raw material for the porous carbon can include peat, a coconut husk-derived material, a sawdust-derived material and an alkaline treated plant-derived material, where the coconut husk-derived material and the sawdust-derived material are typically known as a medicinal carbon. These materials may be used alone as a raw material, or some types of them may be used in combination. The shape and the form of the plant-derived material are not specifically limited. For example, hulls and straws may be as-is used, or dehydrated products may be used. Furthermore, materials subjected to various treatments, e.g., a fermentation treatment, a roasting treatment, and a extraction treatment, in food and drink processing of beer, Western liquor, and the like may also be used. In particular, from the viewpoint of resource recovery of industrial waste, it is preferable that straws and hulls after processing, e.g., threshing, be used. These straws and hulls after processing are available from, for example, agricultural cooperative associations, alcoholic drink manufacturers, food-products companies, and food processing companies in large quantity easily.

The porous carbon material has many pores. Pores include “mesopore” having a pore diameter of 2 nm to 50 nm, “micropore” having a pore diameter of less than 2 nm, and “macropore” having a pore diameter of more than 50 nm. Specifically, mesopores include a high proportion of pores having a pore diameter of 20 nm or less, and particularly include a high proportion of pores having a pore diameter of 10 nm or less. Micropores include, for example, a high proportion of pores having a pore diameter of about 1.9 nm, pores having a pore diameter of about 1.5 nm, and pores having a pore diameter of about 0.8 nm to 1 nm. In the porous carbon material, the pore volume is preferably 0.4 cm³/g or more on the basis of the BJH method, and further preferably 0.5 cm³/g or more.

In the porous carbon material, in order to obtain further excellent functionality, it is desirable that the value of specific surface area on the basis of the nitrogen BET method (hereafter may be referred to as “value of specific surface area” simply) be preferably 50 m²/g or more, more preferably 100 m²/g or more, and further preferably 400 m²/g or more.

The nitrogen BET method refers to a method in which an adsorption isotherm is measured by allowing an adsorbent (here, porous carbon material) to adsorb and desorb nitrogen serving as an adsorbate molecule, the resulting data are analyzed on the basis of the BET equation represented by Formula (1). The specific surface area, the pore volume, and the like can be calculated on the basis of this method. Specifically, in the case where the value of specific surface area is calculated by the nitrogen BET method, initially, an adsorption isotherm is determined by allowing the porous carbon material to adsorb and desorb nitrogen serving as an adsorbate molecule. Subsequently, [p/{Vₐ(p₀−p)}] is calculated from the resulting adsorption isotherm on the basis of Formula (1) or Formula (1′) transformed from Formula (1), and is plotted with respect to the equilibrium relative pressure (p/p₀). This plot is assumed to be a straight line, and the slope s (=[(C−1)/(CVₘ)]) and the intercept i (=[1/(CVₘ)]) are calculated on the basis of the least squares method. Then, Vₘ and C are calculated from the resulting slope s and intersection the basis of Formula (2-1) and Formula (2-2). In addition, the specific surface area a_{sBET} is calculated from Vₘ on the basis of Formula (3) (refer to Manual of BELSORP-mini and BELSORP analysis software produced by BEL Japan, Inc., pages 62 to 66). This nitrogen BET method is a measuring method in conformity with JIS R 1626-1996 “Measuring method for the specific surface area of fine ceramic powders by gas adsorption using the BET method”.

[Math. 1]

Vₐ=(Vₘ·C·p)/[(p₀−p){1+(C−1)(p/p₀)}] (1)

[p/{Vₐ(p₀−p)}]=[(C−1)/(C−Vₘ)](p/p₀)+[1/(C·Vₘ)] (1′)

Vₘ=1/(s+i) (2-1)

C=(s/i)+1 (2-2)

a_{sBET}=(Vₘ·L·σ)/22414 (3)

Where symbols are defined as described below.
Vₐ: amount of adsorption
Vₘ: amount of adsorption of monomolecular layer
p: equilibrium pressure of nitrogen
p₀: saturated vapor pressure of nitrogen
L: Avogadro's number
sigma: adsorption cross-sectional area of nitrogen

In the case where the pore volume Vₚ is calculated by the nitrogen BET method, for example, the adsorption data of the determined adsorption isotherm are subjected to linear interpolation, and the amount of adsorption V is determined at a relative pressure set with the pore volume calculation relative pressure. The pore volume Vₚ can be calculated from the resulting amount of adsorption V on the basis of Formula (4) (refer to Manual of BELSORP-mini and BELSORP analysis software produced by BEL Japan, Inc., pages 62 to 65). In this regard, the pore volume on the basis of the nitrogen BET method may be hereafter referred to as “pore volume” simply.

[Math. 2]

Vₚ=(V/22414)×(M_{g}/ρ_{g}) (4)

Where symbols are defined as described below.
V: amount of adsorption at relative pressure
M_{g}: molecular weight of nitrogen
rho_{g}: density of nitrogen

The pore diameter of the mesopore can be calculated as the distribution of pores from the rate of change in pore volume with respect to the pore diameter on the basis of, for example, the BJH method. The BJH method is a method widely used as a pore distribution analysis method. In the case where the pore distribution is analyzed on the basis of the BJH method, initially, a desorption isotherm is determined by allowing the porous carbon material to adsorb and desorb nitrogen serving as an adsorbate molecule. Subsequently, the thicknesses of adsorption layers when the adsorbate molecules are desorbed stepwise from the state in which pores are filed with the adsorbate molecules (for example, nitrogen) and the inside diameter (twice as much as the core radius) of the hole generated at that time are determined on the basis of the resulting desorption isotherm, the pore radius rₚ is calculated on the basis of Formula (5), and the pore volume is calculated on the basis of Formula (6). Then, the rate of change in pore volume (dVₚ/drₚ) with respect to the pore diameter (2rₚ) is plotted on the basis of the pore radius and the pore volume and, thereby, a pore distribution curve is obtained (refer to Manual of BELSORP-mini and BELSORP analysis software produced by BEL Japan, Inc., pages 85 to 88).

[Math. 3]

rₚ=t+rₖ (5)

Vₚₙ=Rₙ·dVₙ−Rₙ·dtₙ·c·ΣAₚⱼ (6)

Rₙ=rₚₙ²/(rₖₙ−1+dtₙ)² (7)

Where symbols are defined as described below.
rₚ: pore radius
rₖ: core radius (inside diameter/2) in the case where an adsorption layer having a thickness of t is adsorbed to the inside wall of a pore having a pore radius rₚ at that pressure
Vₚₙ: pore volume when the nth desorption of nitrogen has occurred
dVₙ: amount of change at that time
dtₙ: amount of change in thickness tₙ of adsorption layer when the nth desorption of nitrogen has occurred
rₖₙ: core radius at that time
c: fixed value
rₚₙ: pore radius when the nth desorption of nitrogen has occurred

### Meanwhile,

[Math. 4]

ΣAₚⱼ

represents an integrated value of the area of the wall surface of the pore of j=1 to j=n−1.

The pore diameter of the micropore can be calculated as the distribution of pores from the rate of change in pore volume with respect to the pore diameter on the basis of the MP method. In the case where the pore distribution is analyzed on the basis of the MP method, initially, an absorption isotherm is determined by allowing the porous carbon material to adsorb nitrogen. Subsequently, the resulting adsorption isotherm is converted to the pore volume with respect to the thickness t of the adsorption layer (plotted with respect to t). Then, a pore distribution curve can be obtained on the basis of the curvature of the resulting plot (the amount of change in pore volume with respect to the amount of change in thickness t of the adsorption layer) (refer to Manual of BELSORP-mini and BELSORP analysis software produced by BEL Japan, Inc., pages 72, 73, and 82).

The porous carbon material precursor is treated with an acid or alkali. Specific examples of the treatment method may include a method in which the porous carbon material precursor is immersed in an acid or alkali aqueous solution and a method in which the porous carbon material precursor is reacted with an acid or alkali in a vapor phase. More specifically, in the case where an acid treatment is performed, examples of acids may include fluorine compounds exhibiting acidity, e.g., hydrogen fluoride, hydrofluoric acid, ammonium fluoride, calcium fluoride, and sodium fluoride. In the case where a fluorine compound is used, it is enough that the amount of fluorine element is four times the amount of silicon element in the silicon component contained in the porous carbon material precursor, and it is preferable that the concentration of the fluorine compound aqueous solution be 10 percent by mass or more. In the case where the silicon component (for example, silicon dioxide) contained in the porous carbon material precursor is removed by hydrofluoric acid, silicon dioxide is reacted with hydrofluoric acid as shown in Chemical formula (A) or Chemical formula (B) and is removed as hexafluorosilicic acid (H₂SiF₆) or silicon tetrafluoride (SiF₄), so that the porous carbon material intermediate can be obtained. Thereafter, washing and drying may be performed.

[Chem. 1]

SiO₂+6HF→H₂SiF₆+2H₂O (A)

SiO₂+4HF→SiF₄+2H₂O (B)

In the case where an alkali (base) treatment is performed, examples of alkali may include sodium hydroxide. In the case where an alkali aqueous solution is used, it is enough that the pH of the aqueous solution is 11 or more. In the case where the silicon component (for example, silicon dioxide) contained in the porous carbon material precursor is removed by sodium hydroxide aqueous solution, the sodium hydroxide aqueous solution is heated and, thereby, silicon dioxide is reacted as shown in Chemical formula (C) and is removed as sodium silicate (Na₂SiO₃), so that the porous carbon material intermediate can be obtained. Meanwhile, in the case where the treatment is performed by reacting sodium hydroxide in a vapor phase, solid sodium hydroxide is heated and, thereby, silicon dioxide is reacted as shown in Chemical formula (C) and is removed as sodium silicate (Na₂SiO₃), so that the porous carbon material intermediate can be obtained. Thereafter, washing and drying may be performed.

[Chem. 2]

SiO₂₊₂NaOH→Na₂SiO₃+H₂O (C)

### Example 1

Example 1 relates to the electrode materials, the methods for manufacturing the electrode materials, and the secondary batteries according to the first embodiment and the second embodiment of the present disclosure.

An electrode material for a secondary battery in Example 1 was made from a porous carbon material exhibiting a half-width of diffraction intensity peak of the (100) face or (101) face of 4 degrees or less with reference to a diffraction angle 2 theta on the basis of an X-ray diffraction method. Alternatively, an electrode material for a secondary battery in Example 1 was made from a porous carbon material, wherein an absolute value of a differential value of mass, that was obtained when a mixture of the porous carbon material and S₈ sulfur mixed at a mass ratio of 1:2 was subjected to thermal analysis, where temperature was employed as a parameter, (absolute value of −dW/dt) took on a value of more than 0 at 450 degrees centigrade and a value of 1.9 or more (preferably 2.0 or more) at 400 degrees centigrade.

A secondary battery in Example 1 included an electrode made from a porous carbon material exhibiting a half-width of diffraction intensity peak of the (100) face or (101) face of 4 degrees or less with reference to a diffraction angle 2 theta on the basis of an X-ray diffraction method. Alternatively, a secondary battery in Example 1 was a secondary battery including an electrode made from a porous carbon material, wherein an absolute value of a differential value of mass, that was obtained when a mixture of the porous carbon material and S₈ sulfur mixed at a mass ratio of 1:2 was subjected to thermal analysis, where temperature was employed as a parameter, (absolute value of −dW/dt) took on a value of more than 0 at 450 degrees centigrade and a value of 1.9 or more (preferably 2.0 or more) at 400 degrees centigrade.

In a method for manufacturing an electrode material for a secondary battery in Example 1, the above-described electrode material for a secondary battery in Example 1 was obtained by carbonizing a plant-derived material at 400 degrees centigrade to 1,400 degrees centigrade, performing an acid or alkali treatment, and performing a heat treatment at a temperature higher than the carbonization temperature.

Specifically, hulls which were plant-derived materials having a silicon (Si) content of 5 percent by mass or more were used as the raw material, and carbonization (firing) was performed at 800 degrees centigrade in a nitrogen atmosphere, so that a porous carbon material precursor was obtained. The resulting porous carbon material precursor was immersed in a 48-percent by volume hydrofluoric acid aqueous solution for a night so as to perform an acid treatment and, thereby, a silicon component in the plant-derived material after carbonization was removed. Thereafter, washing was performed by using water and ethyl alcohol until the pH reached 7. Then, drying was performed, so that a porous carbon material intermediate was obtained. Subsequently, the temperature was raised to 900 degrees centigrade in a nitrogen atmosphere, and activation treatment with steam was performed. The temperature of the porous carbon material intermediate subjected to the activation treatment was raised to a predetermined temperature, at which a heat treatment was performed, at a temperature raising rate of 5 degrees centigrade/min. After the predetermined temperature was reached, the predetermined temperature was maintained for 1 hour, so that a porous carbon material was obtained. The silicon (Si) content of the resulting porous carbon material was 1 percent by mass or less. The porous carbon material had a value of specific surface area of 10 m²/g or more on the basis of the nitrogen BET method and a pore volume of 0.1 cm³/g or more on the basis of the BJH method and the MP method.

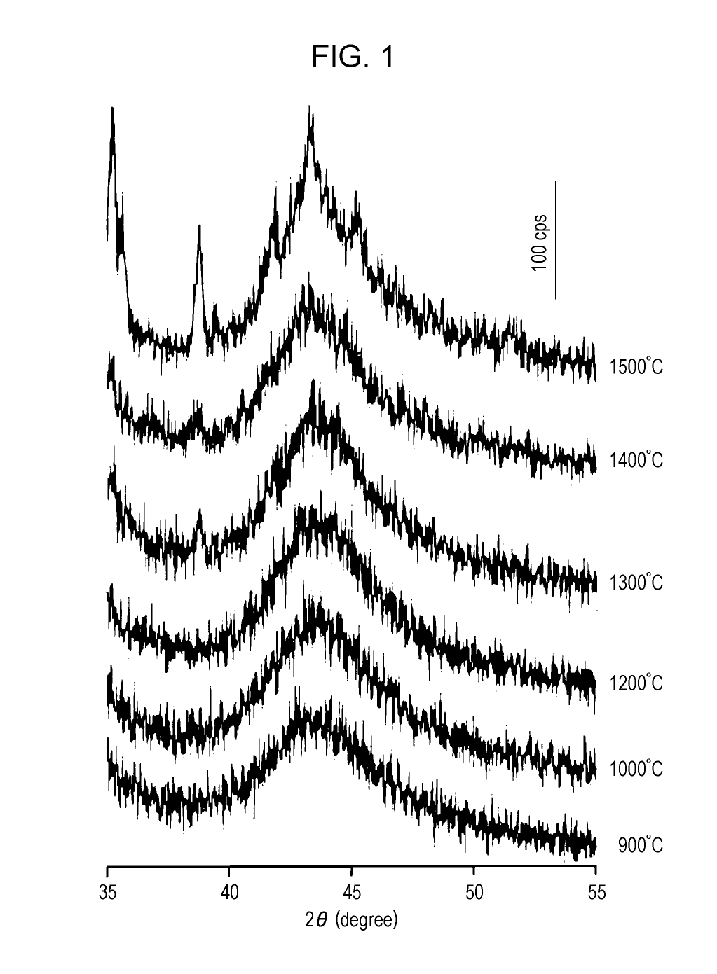

The predetermined temperature were specified to be 900 degrees centigrade (Reference example 1A), 1,000 degrees centigrade (Reference example 1B), 1,200 degrees centigrade (Reference example 1C), 1,300 degrees centigrade (Example 1A), 1,400 degrees centigrade (Example 1B), and 1,500 degrees centigrade (Example 1C). Each of the resulting porous carbon materials at predetermined temperatures was subjected to the XRD measurement by using an X-ray diffractometer (RINT-TTRII) produced by Rigaku Corporation. The measurement results of half-width of diffraction intensity peak of the (100) face or (101) face on the basis of the X-ray diffraction method are shown in Table 1 described below. The measurement results of the diffraction intensity are indicated in a graph shown in FIG. 1. In this regard, the value of half-width of diffraction intensity peak of the (100) face or (101) face of the porous carbon material intermediate on the basis of the X-ray diffraction method was equivalent to the value of Reference example 1A.

TABLE 1

| Predetermined temperature | Half-value |
|---|---|
| 900° C. (Reference example 1A) | 4.8 degrees |
| 1,000° C. (Reference example 1B) | 4.8 degrees |
| 1,200° C. (Reference example 1C) | 4.8 degrees |
| 1,300° C. (Example 1A) | 3.9 degrees |
| 1,400° C. (Example 1B) | 3.9 degrees |
| 1,500° C. (Example 1C) | 3.0 degrees |

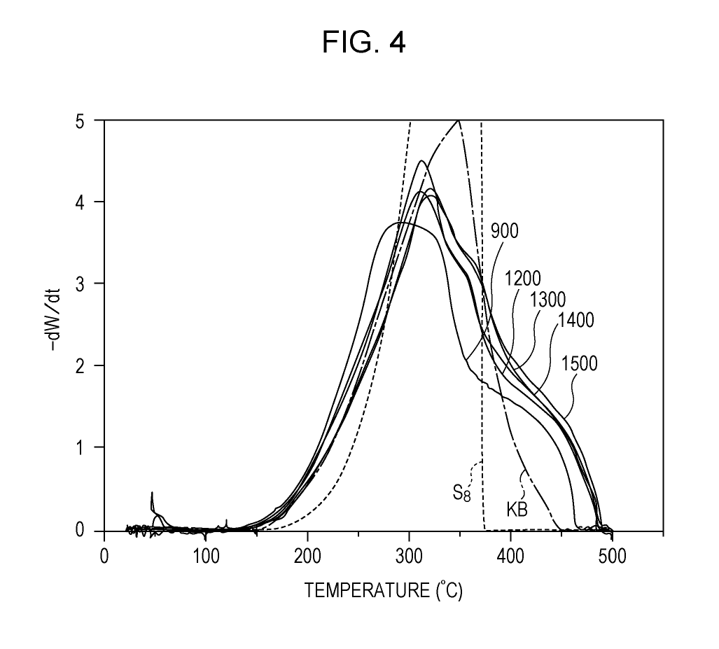

The measurement result of TG of the mixture of the porous carbon material at each of the predetermined temperatures and S₈ sulfur was shown in FIG. 3, and the measurement results of TG of S₈ sulfur and Ketjenblack (KB) are also shown in FIG. 3. In addition, absolute value of differential value of mass, where temperature was employed as a parameter, (absolute value of −dW/dt) are shown in FIG. 4. As shown in Table 2 described below, the absolute value of −dW/dt of each porous carbon material in Example 1 was more than 0 at 450 degrees centigrade and was 1.9 or more at 400 degrees centigrade. In this regard, the absolute values of −dW/dt of the porous carbon material intermediate at 400 degrees centigrade and 450 degrees centigrade were equivalent to the values of Reference example 1A.

TABLE 2

| | \|−dW/dt\| | |
|---|---|---|
| Predetermined temperature | Value at 450° C. | Value at 400° C. |
| 900° C. (Reference example 1A) | 1.21 | 1.60 |
| 1,000° C. (Reference example 1B) | 1.29 | 1.77 |
| 1,200° C. (Reference example 1C) | 1.28 | 1.83 |
| 1,300° C. (Example 1A) | 1.41 | 2.16 |
| 1,400° C. (Example 1B) | 1.31 | 1.98 |
| 1,500° C. (Example 1C) | 1.25 | 2.00 |
| S₈ sulfur | 0 | 0 |
| Ketjenblack | 0 | 1.26 |

The measurement results of pores and the like of each porous carbon material are shown in Table 3 described below. In Table 3, the terms “nitrogen BET method”, “MP method”, and “BJH method” refers to the value of specific surface area (unit: m²/g) on the basis of the nitrogen BET method, the value of pore volume (unit: cm³/g) on the basis of the MP method, and the value of pore volume (unit: cm³/g) on the basis of the BJH method, respectively. The unit of the total pore volume is “cm³/g”.

TABLE 3

| Predetermined | Nitrogen | Total pore | MP | BJH |
|---|---|---|---|---|
| temperature | BET method | volume | method | method |
| 900° C. (Reference | 1472 | 1.18 | 0.646 | 0.733 |
| example 1A) | | | | |
| 1,000° C. (Reference | 1489 | 1.16 | 0.646 | 0.686 |
| example 1B) | | | | |
| 1,200° C. (Reference | 1445 | 1.15 | 0.624 | 0.674 |
| example 1C) | | | | |
| 1,300° C. | 1438 | 1.19 | 0.589 | 0.780 |
| (Example 1A) | | | | |
| 1,400° C. | 1326 | 0.96 | 0.627 | 0.550 |
| (Example 1B) | | | | |
| 1,500° C. | 1268 | 1.07 | 0.502 | 0.717 |
| (Example 1C) | | | | |
| Porous carbon material | 1590 | 1.29 | 0.646 | 0.825 |
| intermediate | | | | |

An electrode was produced by using the porous carbon material and the like, and a lithium-sulfur secondary battery was prototyped. A positive electrode is formed from the electrode, and sulfur was carried by the electrode.

A positive electrode of a lithium-sulfur secondary battery was prototyped by using S₈ sulfur, the porous carbon material in Example 1, and other materials. Specifically, a slurry having the composition shown in Table 4 described below was prepared. In this regard, the term “KS6” refers to a carbon material produced by TIMCAL Graphite & Carbon, the term “VGCF” refers to a vapor-grown carbon fiber produced by SHOWA DENKO K.K., and the term “PVDF” is the abbreviated name for polyvinylidene fluoride which functions as a binder.

TABLE 4

| | Percent by mass |
|---|---|
| S₈ sulfur | 60 |
| Porous carbon material | 28 |
| KS6 | 5.25 |
| VGCF | 1.75 |
| PVDF | 5 |

More specifically, in a mortar, 5 percent by mass of polyvinyl alcohol (PVA) which functions as a binder was added to the above-described composition (positive electrode material), N-methyl pyrrolidone (NMP) serving as a solvent was further added, and kneading was performed, so that a slurry state was brought about. The kneaded material was applied to aluminum foil, and hot air drying was performed at 120 degrees centigrade for 3 hours. Hot pressing was performed by using a hot press machine under the condition of a temperature of 80 degrees centigrade and a pressure of 580 kgf/cm², so as to increase the density of the positive electrode material, prevent an occurrence of damage due to contact with an electrolytic solution, and reduce the resistance value. Subsequently, punching was performed in such a way that the diameter became 15 mm, and vacuum drying was performed at 60 degrees centigrade for 3 hours to remove water and the solvent. The thickness of the thus obtained positive electrode portion excluding the aluminum foil (positive electrode material layer) was 80 micrometers to 100 micrometers, the mass was 8 mg to 12 mg, and the density was about 0.6 g/cm³. The thus obtained positive electrode was used and a lithium-sulfur secondary battery made from a 2016 coin battery was assembled. Specifically, the lithium-sulfur secondary battery made from the 2016 coin battery was assembled by stacking the positive electrode including the aluminum foil and the positive electrode material layer, the electrolytic solution, lithium foil having a thickness of 0.8 mm, and a nickel mesh. As for the electrolytic solution, a solution in which 0.5 mol LiTFSI/0.4 mol LiNO₃ was dissolved in a mixed solvent of dimethyl ether and 1,3-dioxane (volume ratio 1/1) was used.

The charge-discharge test condition of the lithium-sulfur secondary battery was as shown in Table 5 described below.

TABLE 5

| | |
|---|---|
| Current | 0.1 mA (0.057 mA per cm² positive electrode) |
| Cut-off | discharge: 1.5 V (constant current discharge) |
| | charge: 3.5 V (constant current/constant voltage charge) |

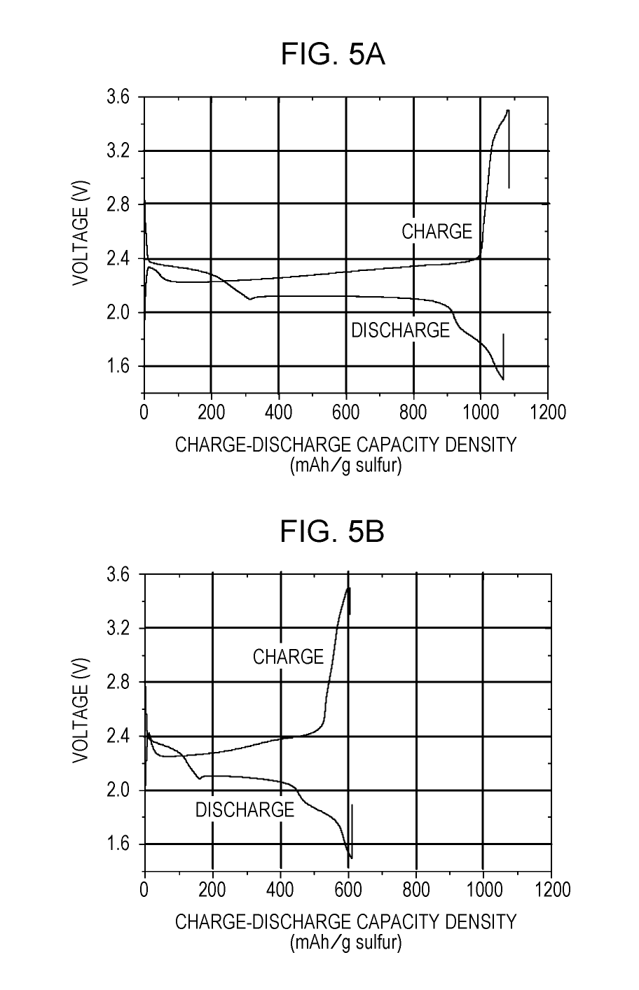

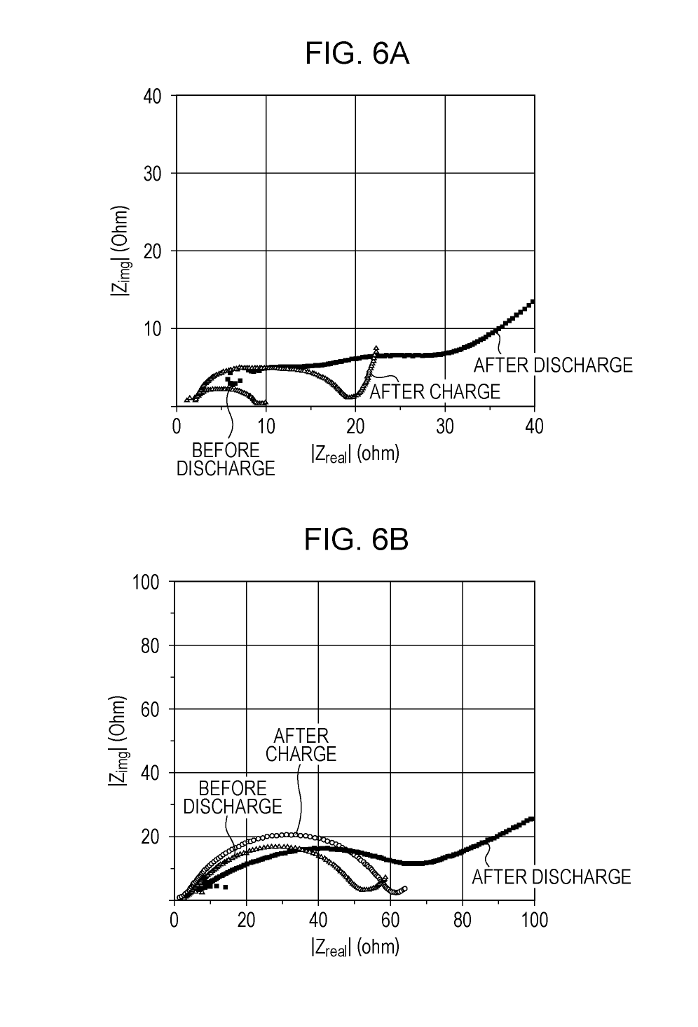

The porous carbon material in Example 1B and the porous carbon material intermediate were used as electrode materials, and a lithium-sulfur secondary battery for evaluation was prototyped. After production, discharge was performed to determine the discharge capacity density, and charge was performed to determine the charge capacity density. The results thereof are shown in FIG. 5A (porous carbon material in Example 1B was used) and FIG. 5B (porous carbon material intermediate was used). The measurement results of impedance after production, the measurement results of impedance after discharge, and the measurement results of impedance after charge thereafter are shown in FIG. 6A (porous carbon material in Example 1B was used) and FIG. 6B (porous carbon material intermediate was used) as Nyquist plots. The terms “before discharge”, “after discharge”, and “after charge” shown in FIG. 6A and FIG. 6B indicate the battery internal resistance value on the basis of an impedance measurement after the lithium-sulfur secondary battery for evaluation was prototyped, the battery internal resistance value on the basis of an impedance measurement after discharge was performed, and the battery internal resistance value after charge was performed following the discharge, respectively. In this regard, the resistance component of the negative electrode and the electrolytic solution (including the interface resistance) is about 5 ohms and, therefore, most of the resistance components derived from arcs shown in FIG. 6A and FIG. 6B are the resistance of the positive electrode.

As is clear from FIG. 5A and FIG. 5B, the example secondary battery including the porous carbon material in Example 1B has a high charge-discharge capacity density as compared with the comparative example secondary battery including the porous carbon material intermediate. Meanwhile, as is clear from FIG. 6A and FIG. 6B, the example secondary battery including the porous carbon material in Example 1B has a low positive electrode resistance value as compared with that of the comparative example secondary battery including the porous carbon material intermediate. In this regard, five lithium-sulfur secondary batteries for evaluation were prototyped so as to be subjected to the test, and the same results were obtained with respect to all the lithium-sulfur secondary batteries for evaluation. The example secondary batteries including the porous carbon material in Example 1B were able to be subjected to 50 times or more of charge and discharge, whereas no comparative example secondary batteries including the porous carbon material intermediate exhibited the number of times of charge and discharge of more than 10 times.

The characteristics of the example secondary batteries including the porous carbon materials in Example 1A and Example 1C were substantially equivalent to the characteristics of the example secondary battery including the porous carbon material in Example 1B. On the other hand, the characteristics of the example secondary batteries including the porous carbon materials in Reference example 1A, Reference example 1B, and Reference example 1C were substantially equivalent to the characteristics of the comparative example secondary battery including the porous carbon material intermediate.

As described above, in the electrode material for a secondary battery and the manufacturing method therefor in Example 1 and the secondary battery in Example 1, the value of half-width of diffraction intensity peak of the (100) face or (101) face of the porous carbon material on the basis of an X-ray diffraction method is specified. That is, the porous carbon material has high crystallinity. Therefore, the porous carbon material in Example 1 has excellent electrical conductivity. The secondary battery in which this porous carbon material is used as an electrode can improve the utilization factor of an active material and, in addition, has excellent charge-discharge cycle characteristics. Also, in the electrode material for a secondary battery and the manufacturing method therefor in Example 1 and the secondary battery in Example 1, thermal behavior of a mixture of the porous carbon material and S₈ sulfur is specified. That is, even when heat is applied, sulfur does not leave the mixed system of the porous carbon material and S₈ sulfur easily. As a result, this porous carbon material can hold an active material in the pores thereof reliably and outflow of reaction products, which are generated in gaps, of the active material from the pores to the outside can be prevented. Consequently, the utilization factor of the active material can be improved and, in addition, excellent charge-discharge cycle characteristics are exhibited.

Up to this point, the present disclosure has been explained with reference to the favorable examples. However, the present disclosure is not limited to these examples and can be variously modified. In the examples, the case where hulls are used as the raw material of the porous carbon material has been explained, although other plants may be used as the raw material. Examples of other plants may include straw, reed, wakame stem, terrestrial vascular plants, pteridophyte, bryophyte, algae, and sea grass. These plants may be used alone, or some types of them may be used in combination. Specifically, for example, the plant-derived material, which is the raw material for the porous carbon material, is specified to be rice straw (for example, isehikari of Kagoshima origin), and the porous carbon material can be obtained by carbonizing the straw serving as the raw material to convert to a carbonaceous substance (porous carbon material precursor) and performing an acid treatment. Alternatively, the plant-derived material, which is the raw material for the porous carbon material, is specified to be gramineous reed, and the porous carbon material can be obtained by carbonizing the reed serving as the raw material to convert to a carbonaceous substance (porous carbon material precursor) and performing an acid treatment. The same result was obtained in the case of a porous carbon material obtained by treating with alkali (base), e.g., a sodium hydroxide aqueous solution, in place of the hydrofluoric acid aqueous solution. The method for manufacturing the porous carbon material may be the same as that in Example 1.

Alternatively, the plant-derived material, which is the raw material for the porous carbon material, is specified to be wakame stem (Sanriku in Iwate prefecture origin), and the porous carbon material can be obtained by carbonizing the wakame stem serving as the raw material to convert to a carbonaceous substance (porous carbon material precursor) and performing an acid treatment. Specifically, for example, wakame stem is heated at a temperature of about 500 degrees centigrade so as to be carbonized. For example, the wakame stem serving as the raw material may be treated with alcohol before heating. As for a specific treating method, a method in which immersion in ethyl alcohol or the like is performed is mentioned and, thereby, water contained in the raw material can be reduced and, in addition, elements other than carbon and mineral components contained in the finally obtained porous carbon material can be eluted. Furthermore, generation of gases during carbonization can be suppressed by this treatment with alcohol. More specifically, the wakame stem is immersed in ethyl alcohol for 48 hours. It is preferable that an ultrasonic treatment be performed in ethyl alcohol. Subsequently, the resulting wakame stem is carbonized by heating in a nitrogen stream at 500 degrees centigrade for 5 hours, so as to obtain a carbonized material. A tar component, which may be generated in the following carbonization, can be reduced or removed by performing such a treatment (pre-carbonization treatment). Thereafter, 10 g of the resulting carbonized material is put into an alumina crucible, and temperature is raised to 1,000 degrees centigrade in a nitrogen stream (10 l/min) at a temperature raising rate of 5 degrees centigrade/min. Carbonization is performed at 1,000 degrees centigrade for 5 hours to induce conversion to a carbonaceous substance (porous carbon material precursor), and cooling to room temperature is performed. The nitrogen gas is continuously passed during carbonization and cooling. An acid treatment is performed by immersing the resulting porous carbon material precursor in a 46-percent by volume hydrofluoric acid aqueous solution for a night, and washing is performed by using water and ethyl alcohol until the pH 7 is reached. Finally, drying is performed, so that a porous carbon material can be obtained.

The present disclosure can also have the following configurations.

### [1] [Electrode Material: First Embodiment]

An electrode material for a secondary battery made from a porous carbon material exhibiting a half-width of diffraction intensity peak of the (100) face or (101) face of 4 degrees or less with reference to a diffraction angle 2 theta on the basis of an X-ray diffraction method.

### [2] [Electrode Material: Second Embodiment]

An electrode material for a secondary battery made from a porous carbon material, wherein an absolute value of a differential value of mass, that is obtained when a mixture of the porous carbon material and S₈ sulfur mixed at a mass ratio of 1:2 is subjected to thermal analysis, where temperature is employed as a parameter, takes on a value of more than 0 at 450 degrees centigrade and a value of 1.9 or more at 400 degrees centigrade.

[3] The electrode material for a secondary battery according to the item [2], wherein the half-width of diffraction intensity peak of the (100) face or (101) face of the porous carbon material is 4 degrees or less with reference to a diffraction angle 2 theta on the basis of an X-ray diffraction method.
[4] The electrode material for a secondary battery according to any one of the items [1] to [3], wherein the porous carbon material has a value of specific surface area of 10 m²/g or more on the basis of a nitrogen BET method and a pore volume of 0.1 cm³/g or more on the basis of a BJH method and a MP method.
[5] The electrode material for a secondary battery according to the item [4], wherein the raw material for the porous carbon material is a plant-derived material having a silicon content of 5 percent by mass or more.

### [6] [Secondary Battery: First Embodiment]

A secondary battery including an electrode made from a porous carbon material exhibiting a half-width of diffraction intensity peak of the (100) face or (101) face of 4 degrees or less with reference to a diffraction angle 2 theta on the basis of an X-ray diffraction method.

### [7] [Secondary Battery: Second Embodiment]

A secondary battery including an electrode made from a porous carbon material, wherein an absolute value of a differential value of mass, that is obtained when a mixture of the porous carbon material and S₈ sulfur mixed at a mass ratio of 1:2 is subjected to thermal analysis, where temperature is employed as a parameter, takes on a value of more than 0 at 450 degrees centigrade and a value of 1.9 or more at 400 degrees centigrade.

[8] The secondary battery according to the item [7], wherein the half-width of diffraction intensity peak of the (100) face or (101) face of the porous carbon material is 4 degrees or less with reference to a diffraction angle 2 theta on the basis of an X-ray diffraction method.
[9] The secondary battery according to any one of the items [6] to [8], wherein the porous carbon material has a value of specific surface area of 10 m²/g or more on the basis of a nitrogen BET method and a pore volume of 0.1 cm³/g or more on the basis of a BJH method and a MP method.
[10] The secondary battery according to the item [9], wherein the raw material for the porous carbon material is a plant-derived material having a silicon content of 5 percent by mass or more.
[11] The secondary battery according to any one of the items [6] to [10], wherein a positive electrode is formed from the electrode.
[12] The secondary battery according to any one of the items [6] to [11], wherein the secondary battery is made from a lithium-sulfur secondary battery, and the electrode carries sulfur or a sulfur compound.

### [13] [Method for Manufacturing Electrode Material: First Embodiment]

A method for manufacturing an electrode material for a secondary battery made from a porous carbon material exhibiting a half-width of diffraction intensity peak of the (100) face or (101) face of 4 degrees or less with reference to a diffraction angle 2 theta on the basis of an X-ray diffraction method, the manufacturing method including carbonizing a plant-derived material at 400 degrees centigrade to 1,400 degrees centigrade, performing an acid or alkali treatment, and performing a heat treatment at a temperature higher than the carbonization temperature.

### [14] [Method for Manufacturing Electrode Material: Second Embodiment]

A method for manufacturing an electrode material for a secondary battery which is made from a porous carbon material and which exhibits an absolute value of a differential value of mass, that is obtained when a mixture of the porous carbon material and S₈ sulfur mixed at a mass ratio of 1:2 is subjected to thermal analysis, where temperature is employed as a parameter, taking on a value of more than 0 at 450 degrees centigrade and a value of 1.9 or more at 400 degrees centigrade, the manufacturing method including carbonizing a plant-derived material at 400 degrees centigrade to 1,400 degrees centigrade, performing an acid or alkali treatment, and performing a heat treatment at a temperature higher than the carbonization temperature.

[15] The method for manufacturing an electrode material for a secondary battery, according to the item [14], wherein the half-width of diffraction intensity peak of the (100) face or (101) face of the porous carbon material is 4 degrees or less with reference to a diffraction angle 2 theta on the basis of an X-ray diffraction method.
[16] The method for manufacturing an electrode material for a secondary battery, according to any one of the items [13] to [15], wherein the porous carbon material has a value of specific surface area of 10 m²/g or more on the basis of a nitrogen BET method and a pore volume of 0.1 cm³/g or more on the basis of a BJH method and a MP method.
[17] The method for manufacturing an electrode material for a secondary battery, according to the item [16], wherein the raw material for the porous carbon material is a plant-derived material having a silicon content of 5 percent by mass or more.
[18] The method for manufacturing an electrode material for a secondary battery, according to any one of the items [13] to [17], wherein a silicon component in the plant-derived material after carbonization is removed by the acid or alkali treatment.
[19] An electrode material comprising: a porous carbon material, wherein the porous carbon material has a half-width of diffraction intensity peak of a (100) face or a (101) face of 4 degrees or less with reference to a diffraction angle 2 theta on a basis of an X-ray diffraction method.
[20] The electrode material according to [19], wherein a sulfur material is carried in pores of the porous carbon material.
[21] The electrode material according to [20], wherein the sulfur material is selected from the group consisting of: S₈ sulfur, insoluble sulfur, colloidal sulfur and an organic sulfur compound.
[22] The electrode material according to [19], wherein the porous carbon material has a specific surface area of 10 m²/g or more on a basis of a nitrogen BET method.
[23] The electrode material according to [19], wherein the porous carbon material has a pore volume of 0.1 cm³/g or more on a basis of a BJH method and a MP method.
[24] The electrode material according to [19], wherein a raw material for the porous carbon material is a plant-derived material having a silicon content of 5 percent by mass or more.
[25] The electrode material according to [19], wherein a raw material for the porous carbon material is selected from the group consisting of: peat, a coconut husk-derived material, a sawdust-derived material and an alkaline treated plant-derived material.
[26] The electrode material according to claim [19], wherein a silicon content of the porous carbon material is less than 5 percent by mass.
[27] A battery comprising: a positive electrode; and a negative electrode, wherein the positive electrode includes an electrode material comprising a porous carbon material, and wherein the porous carbon material has a half-width of diffraction intensity peak of a (100) face or a (101) face of 4 degrees or less with reference to a diffraction angle 2 theta on a basis of an X-ray diffraction method.
[28] An electrode material comprising: a porous carbon material, wherein an absolute value of a differential value of mass obtained when a mixture of the porous carbon material and S₈ sulfur mixed at a mass ratio of 1:2 is subjected to thermal analysis, where temperature is employed as a parameter, has a value of more than 0 at 450° C. and a value of 1.9 or more at 400° C.
[29] A battery comprising: a positive electrode; and a negative electrode, wherein the positive electrode includes an electrode material comprising a porous carbon material, and wherein an absolute value of a differential value of mass obtained when a mixture of the porous carbon material and S₈ sulfur mixed at a mass ratio of 1:2 was subjected to thermal analysis, where temperature is employed as a parameter, has a value of more than 0 at 450° C. and a value of 1.9 or more at 400° C.
[30] A method of manufacturing an electrode material comprising: carbonizing a plant-derived material at a first temperature; performing an acid treatment or an alkali treatment on the carbonized plant-derived material to form a porous carbon material; and subjecting the porous carbon material to a heat treatment at a second temperature, wherein the second temperature is higher than the first temperature.
[31] The method of manufacturing an electrode material according to [30], wherein the first temperature ranges from 400° C. to 1,400° C.
[32] The method of manufacturing an electrode material according to [30], wherein the plant-derived material has a silicon content greater than 5 percent by mass.
[33] The method of manufacturing according to [30], wherein a raw material for the porous carbon material is selected from the group consisting of: peat, a coconut husk-derived material, a sawdust-derived material and an alkaline treated plant-derived material.
[34] The method of manufacturing an electrode material according to [30], further comprising performing an activation treatment on the plant-derived material.
[35] The method of manufacturing an electrode material according to [30], further comprising performing a pre-carbonization treatment on the plant-derived material before the carbonizing step, wherein the pre-carbonization treatment is performed at a temperature lower than the first temperature under a state in which oxygen is cut off.
[36] The method of manufacturing an electrode material according to [30], further comprising immersing the plant-derived material in an alcohol before the carbonizing step.

The present disclosure contains subject matter related to that disclosed in Japanese Priority Patent Application JP 2012-177114 filed in the Japan Patent Office on Aug. 9, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. An electrode material comprising: a porous carbon material, wherein the porous carbon material has a half-width of diffraction intensity peak of a (100) face or a (101) face of 4 degrees or less with reference to a diffraction angle 2 theta on a basis of an X-ray diffraction method.

2. The electrode material according to claim 1, wherein a sulfur material is carried in pores of the porous carbon material.

3. The electrode material according to claim 2, wherein the sulfur material is selected from the group consisting of: S₈ sulfur, insoluble sulfur, colloidal sulfur and an organic sulfur compound.

4. The electrode material according to claim 1, wherein the porous carbon material has a specific surface area of 10 m²/g or more on a basis of a nitrogen BET method.

5. The electrode material according to claim 1, wherein the porous carbon material has a pore volume of 0.1 cm³/g or more on a basis of a BJH method and a MP method.

6. The electrode material according to claim 1, wherein a raw material for the porous carbon material is a plant-derived material having a silicon content of 5 percent by mass or more.

7. The electrode material according to claim 1, wherein a raw material for the porous carbon material is selected from the group consisting of: peat, a coconut husk-derived material, a sawdust-derived material and an alkaline treated plant-derived material.

8. The electrode material according to claim 1, wherein a silicon content of the porous carbon material is less than 5 percent by mass.

9. A battery comprising: a positive electrode; and a negative electrode, wherein the positive electrode includes an electrode material comprising a porous carbon material, and wherein the porous carbon material has a half-width of diffraction intensity peak of a (100) face or a (101) face of 4 degrees or less with reference to a diffraction angle 2 theta on a basis of an X-ray diffraction method.

10. An electrode material comprising: a porous carbon material, wherein an absolute value of a differential value of mass obtained when a mixture of the porous carbon material and S₈ sulfur mixed at a mass ratio of 1:2 is subjected to thermal analysis, where temperature is employed as a parameter, has a value of more than 0 at 450° C. and a value of 1.9 or more at 400° C.

11. A battery comprising: a positive electrode; and a negative electrode, wherein the positive electrode includes an electrode material comprising a porous carbon material, and wherein an absolute value of a differential value of mass obtained when a mixture of the porous carbon material and S₈ sulfur mixed at a mass ratio of 1:2 was subjected to thermal analysis, where temperature is employed as a parameter, has a value of more than 0 at 450° C. and a value of 1.9 or more at 400° C.

12. A method of manufacturing an electrode material comprising: carbonizing a plant-derived material at a first temperature; performing an acid treatment or an alkali treatment on the carbonized plant-derived material to form a porous carbon material; and subjecting the porous carbon material to a heat treatment at a second temperature, wherein the second temperature is higher than the first temperature.

13. The method of manufacturing an electrode material according to claim 12, wherein the first temperature ranges from 400° C. to 1,400° C.

14. The method of manufacturing an electrode material according to claim 12, wherein the plant-derived material has a silicon content greater than 5 percent by mass.

15. The method of manufacturing according to claim 12, wherein a raw material for the porous carbon material is selected from the group consisting of: peat, a coconut husk-derived material, a sawdust-derived material and an alkaline treated plant-derived material.

16. The method of manufacturing an electrode material according to claim 12, further comprising performing an activation treatment on the plant-derived material.

17. The method of manufacturing an electrode material according to claim 12, further comprising performing a pre-carbonization treatment on the plant-derived material before the carbonizing step, wherein the pre-carbonization treatment is performed at a temperature lower than the first temperature under a state in which oxygen is cut off.

18. The method of manufacturing an electrode material according to claim 12, further comprising immersing the plant-derived material in an alcohol before the carbonizing step.
